(19) United States
(12) Patent Application Publication
(10) Pub. No.: US 2012/0111654 A1
(43) Pub. Date: May 10, 2012

(54) SECURE ARRANGEMENT FOR A BATTERY IN A MOTOR VEHICLE

(75) Inventor: Masato Origuchi, Rambouillet (FR)

(73) Assignee: RENAULT SAS, Boulogne Billancourt (FR)

(21) Appl. No.: 13/378,539

(22) PCT Filed: May 31, 2010
(86) PCT No.: PCT/FR2010/051044

§ 371 Date: Jan. 26, 2012

(30) Foreign Application Priority Data
Jun. 16, 2009 (FR) 0954005

(51) Int. Cl. B60R 16/04; H01M 2/10

(52) U.S. Cl. 180/68.5; 429/99

(57) ABSTRACT

An arrangement for a battery in a motor vehicle, including: a recess for the battery which is arranged in the vehicle; and a battery to be vertically inserted into the recess in a first mounting direction up to a mounted position. The recess includes at least one fixed blocking surface relative to the recess, which contacts the periphery of the battery in the mounted position for horizontally immobilizing the battery in every direction.

The invention relates to an arrangement of a bank of accumulator batteries in a motor vehicle.

The invention relates more particularly to an arrangement of a battery in a motor vehicle which comprises:
a housing for the battery, which housing is arranged in the vehicle;
a battery which is intended to be introduced vertically into the housing in a direction of mounting as far as a mounted position.

Vehicles powered by an electric motor require a large amount of electrical power, for example between 15 and 20 kWh to cover a distance of 100 to 150 km.

The source of electrical power is generally formed of at least one bank of electric accumulator batteries. Hereinafter, the term “battery” is to be understood to mean a bank of electric accumulator batteries.

A conventional electric power source such as a domestic wall outlet can supply 3 to 4 kW, allowing such a bank of accumulator batteries to be recharged in around 5 hours. During this recharge time, the vehicle is unavailable.

To solve this problem, it is known practice for a charged spare battery to be substituted for the battery that needs recharging. The discharged battery is thus taken out of the vehicle and replaced with the spare battery. The motor vehicle can thus be used without having to wait for the used up battery to be recharged. This service can, for example, be provided by a station similar to the service stations in existence for cars with combustion engines.

However, a battery of this type is very heavy, for example weighing between 200 and 300 kg, and very bulky, for example representing a slab 800 mm tall and wide by 1000 mm long. These features present problems in designing a simple and effective system for securing the battery in the vehicle. The complexity of the existing securing devices makes the operation of changing the battery a lengthy and painstaking one.

Furthermore, when the motor vehicle is braked sharply, for example in the event of a high speed frontal impact, the battery is likely to experience a horizontal acceleration, generally a longitudinal one, which may be as high as 50 times the acceleration due to gravity. In such a situation, there is a risk that the battery could escape from its housing and break free from the vehicle.

In the existing arrangements, the battery locking mechanism takes care of at least some of the horizontal lockings of the battery. Such a locking mechanism is complicated and expensive to manufacture, notably because of the horizontal loadings that the battery is likely to apply to the locking mechanism in the event of an accident.

To solve these problems, the invention proposes an arrangement of the battery in the vehicle as described hereinabove, characterized in that the housing comprises at least one wedging face which is fixed with respect to the housing which is in contact with the periphery of the battery in the mounted position so as to immobilize the battery horizontally in all directions.

According to other features of the invention:
the wedging face is formed by an annular interior face forming a rigid surround which horizontally surrounds the battery and which is in contact along its entire length with the periphery of the battery in the mounted position so as to block horizontal movements of the battery in all directions;
at least one pad of elastically deformable material is interposed horizontally with preload between the annular interior face and the battery in the mounted position so as to absorb any mounting clearances there are between the battery and the annular interior face so as to ensure that the battery is immobilized relative to the chassis of the vehicle horizontally in all directions;
each wedging face is formed of the interior face of a rigid frame which is fixed to the chassis of the motor vehicle;
the arrangement comprises vertical buffer means against which the battery abuts in its mounted position;
the annular wedging face has a frustoconical shape which collaborates with a counterpart that surrounds the battery horizontally so as to block vertical movement of the battery in the direction of mounting when it is in the mounted position;
the counterpart is produced as an integral part of the battery;
the counterpart is formed of the frustoconical exterior face of a rim which projects horizontally outward from the vertical faces of the battery;
the arrangement comprises locking means for locking the battery in the mounted position and which block vertical movement of the battery in the opposite direction to the direction of mounting;
the locking means comprise at least one hook-shaped catch which is mounted to pivot between a released position in which the battery is free to slide vertically and a locked position in which the battery is trapped in the housing in the mounted position;
in its locked position, the hook-shaped catch is intended to catch under a free lip of the rim;
in its locked position, the hook-shaped catch is intended to catch on a ring borne by the battery;
the axis of pivoting of the catch is arranged, in the direction of gravity, in line with the point of contact between the battery and the catch in the locked position.

Other features and advantages will become apparent from reading the detailed description which follows, for an understanding of which reference may be made to the attached drawings among which:

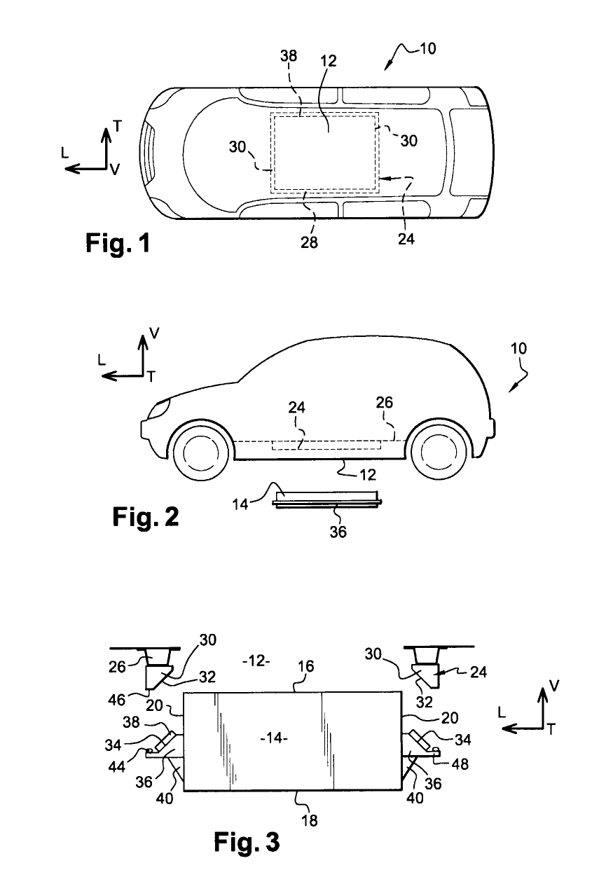

FIG. 1 is a view from above depicting a motor vehicle comprising a battery housing produced in accordance with the teachings of the invention;

FIG. 2 is a side view depicting the vehicle of FIG. 1 and a battery arranged underneath the vehicle prior to being mounted;

FIG. 3 is a detailed view on a larger scale of FIG. 2 depicting the battery and its housing in the vehicle;

FIG. 4 is a detailed view similar to that of FIG. 3 depicting the battery mounted in its housing and fixed by a securing means produced according to a first embodiment of the invention;

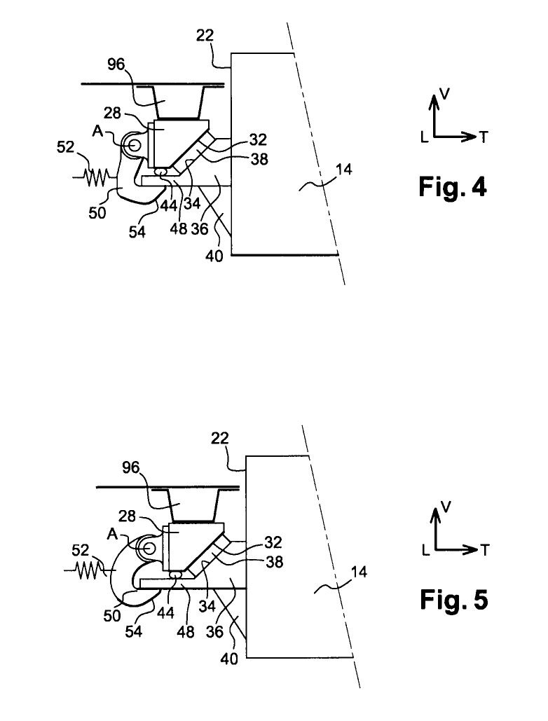

FIG. 5 is a detail view similar to that of FIG. 4 depicting the battery mounted in its housing and fixed by a securing means produced according to a second embodiment of the invention;

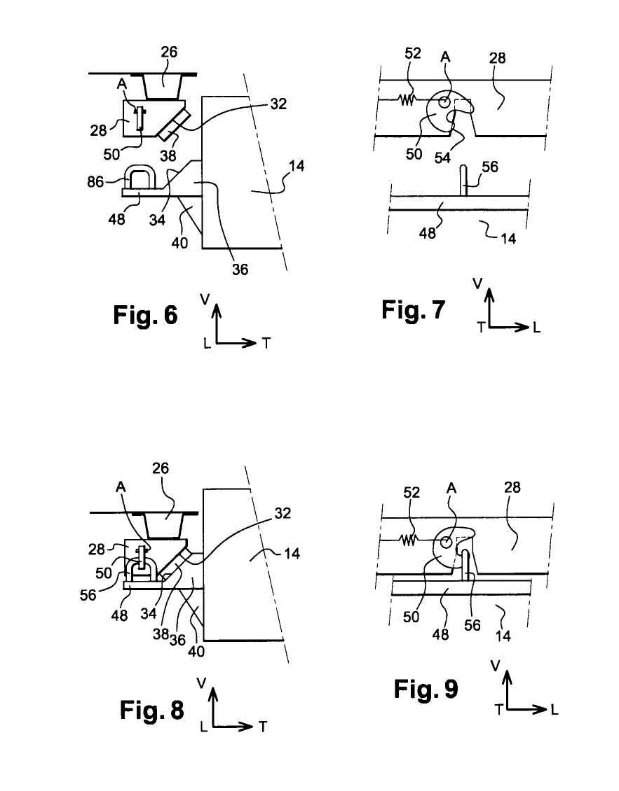

FIG. 6 is a view similar to that of FIG. 4 depicting the battery before it is mounted;

FIG. 7 is a side view of FIG. 6;

FIG. 8 is a view similar to that of FIG. 6 depicting the battery in the mounted position;

FIG. 9 is a side view of FIG. 8.

In the remainder of the description, longitudinal, vertical and transverse orientations indicated by the “L, V, T” trihedron in the figures will be adopted nonlimitingly. Here, the vertical direction is directed in the opposite direction to gravity.

In the remainder of the description, elements having analogous, identical or similar functions will be denoted by the same reference numerals.

FIG. 1 depicts a motor vehicle 10 powered by an electric motor (not depicted) or by a hybrid propulsion device operating in part using an electric motor.

The motor vehicle 10 comprises a housing 12 which is intended to accommodate a bank of electric accumulator batteries 14. The housing 12 is arranged under the motor vehicle 10, substantially in line with the center of gravity of the vehicle 10, and is open downward. The battery 14 is thus intended to be introduced vertically upward into the housing 12 in a direction of mounting as far as a mounted position.

The bank of accumulator batteries 14 is formed of a casing containing electrical energy storage elements (not depicted), such as accumulator batteries, ultra capacitors or the equivalent. Unless specified otherwise, in the remainder of the description, the battery 14 will be likened to the battery casing.

The battery 14 is of rectangular parallelepipedal shape. It is vertically delimited by a horizontal top face 16 and by a horizontal bottom face 18, and is horizontally delimited by a pair of vertical transverse faces 20 and a pair of vertical longitudinal faces 22.

According to the teachings of the invention, the housing 12 comprises at least one wedging face 32 which is fixed to the respective housing 12 which is in contact with the periphery of the battery 14 in the mounted position in order to immobilize the battery 14 horizontally in all directions.

The housing 12 here comprises a rigid horizontal frame which is fixed to the chassis 26 of the motor vehicle 10. The frame 24 has a rectangular shape that more or less complements the horizontal profile of the battery 14.

The frame 24 is made for example of four metal girders, two longitudinal members 28 and two transverse members 30, which are butted together and fixed to one another at right angles and each of which forms one side of the frame 24.

As depicted in FIG. 3, the frame 24 here is fixed securely by its top face to the chassis 26 of the vehicle 10. The frame 24 and the chassis 26 thus form a one piece assembly which is able to withstand very violent impacts, such as are experienced if the vehicle 10 is involved in a high speed head-on collision.

The wedging face here is formed by an annular interior face 32 of the frame 24 that forms a rigid surround intended horizontally to surround the battery 14 in the mounted position. The wedging face 32 is more particularly intended to be in contact, directly or indirectly, over its entire length, with the vertical peripheral faces 20, 22 of the battery 14 in the mounted position in order firmly to block the horizontal movements of the battery 14 in all directions.

According to an undepicted alternative form of the invention, the housing comprises four disjointed wedging faces which are intended each to be in contact with one of the four vertical faces of the battery.

The arrangement also comprises vertical buffer means for blocking the upward vertical movement of the battery 14 in its mounted position.

The vertical buffer means are formed of a fixed face of the housing 12.

Advantageously, the annular welding face 32 of the frame 24 is of a frustoconical, in this instance pyramid, shape, widening toward the bottom which collaborates with a counterpart 34 horizontally surrounding the battery 14 so as to block the vertical movement of the battery 14 in the direction of mounting when the battery is in the mounted position while at the same time performing the horizontal blocking function.

The counterpart is formed of the frustoconical exterior face 34 of a rim 36 that horizontally surrounds the battery 14. The rim 36 in this instance is positioned substantially mid-way up the height of the battery 14 and projects out horizontally from the vertical faces 20, 22 of the battery 14.

The rim 36 here is formed as an integral part of the battery 14.

According to an undepicted alternative form of the battery, the rim is formed of a second frame that is fitted around the battery and is then fixed rigidly to the battery by any suitable fixing means.

The rim 36 has an exterior face 34 of frustoconical shape that complements the wedging face 32 of the frame 24 of the housing 12.

At least one pad 38 of elastically deformable material is interposed horizontally with preload between the annular wedging face 32 of the frame 24 and the battery 14 in the mounted position so as to absorb the mounting clearances there are between the battery 14 and the annular wedging face 32 so as to immobilize the battery with respect to the chassis 26 of the vehicle 10 horizontally in all directions.

In addition, this pad 38 is able very quickly to damp out any oscillations of the battery 14 which are caused for example by the vehicle 10 driving over an uneven road surface.

The arrangement for example comprises four pads 38, each of which is fixed along an entire length of an associated side of the exterior face 34 of the rim 36.

According to an alternative form of embodiment of the invention depicted in FIGS. 6 to 9, the pad or pads 38 are fixed to the wedging face 32 of the frame 24.

In order to improve the ability of the rim 36 to withstand the weight of the battery 14, and as depicted in FIG. 3, vertical ribs 40 are provided here to connect the bottom face of one associated side of the rim 36 to the associated vertical face 20 of the battery 14.

Thus, loads directed vertically upward or horizontally in all directions and which are likely to be applied by the battery are fully absorbed by the frame 24.

Further, means of electrical connection (not depicted) with terminals (not depicted) of the battery 14 are provided inside the housing 12.

In order to prevent water from coming into contact with the means of electrical connection, a sealing gasket 44 is interposed between the rim 36 and the frame 24.

For this reason, the frame 24 has a horizontal bottom face 46 which is arranged facing a free horizontal annular lip 48 that surrounds the exterior face 34 of the rim 36. The gasket 44 is for example fixed to the top face of the horizontal lip 48. Thus, when the battery 14 is in its mounted position, the sealing gasket 44 is compressed vertically between the top face of the lip 48 of the battery 14 and the bottom face 46 of the frame 24.

The free lip 48 of the rim 36 extends out horizontally from the lower base of the exterior surface 34 of the rim 36 as far as a free annular edge.

Furthermore, the rigid frame 24 carries the means of electrical connection to the battery 14. The means of electrical connection are formed for example by a bracket which comprises an upright extending vertically upward from one of the sides 28, 30 of the frame 24 and which comprises an arm carrying electrical connectors.

The means of electrical connection are fixed with respect to the frame 24 so that the battery 14 is electrically connected as it is vertically inserted into the housing 12. For this reason, the electrical connectors are arranged vertically facing corresponding terminals of the battery 14.

Further, as depicted in FIG. 4, the arrangement comprises locking means for locking the battery 14 in the mounted position and which block the vertical movement of the battery 14 in the opposite direction to the direction of mounting, i.e. in the opposite direction to the direction of gravity in the embodiment depicted in the figures. The locking means block only the downward vertical movements of the battery 14. Horizontal movements of the battery 14 are in fact already blocked by the fixed frame 24.

The locking means comprise at least one hook-shaped catch 50 which is mounted to pivot about a horizontal axis “A”, here a longitudinal axis, between a free angular position in which the catch 50 is moved outwardly away so that the battery 14 is free to slide vertically, and an angular locking position in which the battery 14 is trapped in the housing 12 in the mounted position. The catch 50 here is returned elastically to its locking position via an elastic return means 52, for example formed by a spring.

The free lower end of the catch 50 is bent over into a hook shape toward the inside of the frame 24 in the plane of pivoting of the catch 50.

The axis of pivoting “A” is borne by an exterior vertical face of a longitudinal member 28 of the frame 24. The axis of pivoting “A” is positioned so that it is vertically above the facing free lip 48 of the battery 14 in the mounted position.

The catch 50 is intended to catch under the opposing free lip 48 of the battery 14 in the mounted position in order to restrain the battery 14 against the action of its weight.

The vehicle 10 comprises a plurality of locking means, for example four of them, such that the battery 14 rests in a stable manner on several catches 50, and so as to spread the weight of the battery 14 over several catches 50.

Advantageously, the bent-over end of the catch 50 comprises a bottom face 54 that is shaped as a ramp so that as the battery 14 is mounted, the catch 50 is pushed automatically back into its released position by contact with the lip 48 of the battery 14 as it is inserted to allow catching.

In this first embodiment of the locking means, the axis of pivoting “A” of the catch 50 is offset horizontally, in this instance traversely, toward the outside in relation to the opposing lip 48 of the battery 14.

This arrangement of the axis of pivoting “A” makes it possible to obtain locking means that are compact on a horizontal plane.

However, the weight of the battery 14 is then likely to create in the catch 50 a turning moment that counters the elastic return force of the spring 52. The spring 52 has therefore to be rated accordingly.

A second embodiment of the locking means that lock the battery 14 in the mounted position is depicted in FIG. 5. This embodiment is similar to the previous one and so only the differences will be explained hereinafter.

In this second embodiment, the axis of pivoting “A” of the catch 50 is positioned vertically above and in line with the lip 48 of the battery 14 associated with the catch 50. More specifically, the axis of pivoting “A” is positioned vertically in line with the point at which the battery 14 rests on the catch 50. In this way, the loading created by the weight of the battery 14 passes through the axis of pivoting “A”, avoiding the creation of a turning moment in the catch when the battery 14 is locked in the mounted position.

According to a third embodiment of the catching means, which embodiment is depicted in FIGS. 6 to 9, the catch 50 is intended to catch on a ring 56 which extends vertically upward from the top face of the lip 48 of the battery 14 in the mounted position.

This third embodiment allows the designer to orient the catch 50 and its axis of pivoting “A” freely about a vertical axis. Thus, the axis of pivoting “A” of the catch 50 is here directed at right angles to the associated side of the battery 14.

Upon mounting, the battery 14 is arranged underneath the housing 12. The battery 14 is then mounted in an upward vertical translational movement in the direction of mounting until it is arranged in the housing 12.

The catches 50 are pushed back into their released position as a result of contact with the lip 48 of the battery 14. Then, as the battery 14 continues to be mounted as far as its mounted position, the catches 50 are elastically returned to their locked position, catching on the lip 48 of the battery 14.

The pad 38 and the sealing gasket 44 are therefore compressed between the exterior face 34 of the rim 36 of the battery 14 and the wedging face 32 of the frame 24 of the housing 12.

The battery 14 is thus held firmly and without play by the rigid frame 24 horizontally in all directions.

The frame 24 is made of a material that is strong enough not to be deformed by the inertia of the battery in the event of a sharp impact on the vehicle 10.

The frame 24 thus allows the battery 14 to be kept in its housing 12, even in the most extreme conditions and despite the very substantial weight of the battery. The frame 24 thus prevents the battery 14 from being ejected horizontally in an emergency-stop situation or an accident.

Further, the catches 50 are strong enough not to break when the vehicle 10 is driving over an uneven road surface.

Thanks to the arrangements of the invention, the catches 50 have to withstand only downwardly directed vertical loads, i.e. the weight of the battery, the other horizontally-directed or upwardly vertically-directed loads being absorbed by the frame 24. The locking means 50 are therefore simple to design.

In addition, the locking means are likely to be exposed to forces ranging for example only up to ten times the weight of the battery whereas the frame is likely to be exposed to forces ranging up to 50 times the weight of the battery. Thus, the locking means are inexpensive to manufacture.

1-13. (canceled)

14. An arrangement of a battery in a motor vehicle which comprises:
a housing for the battery, which housing is arranged in the vehicle;
a battery configured to be introduced vertically into the housing in a direction of mounting as far as a mounted position;
wherein the housing comprises at least one wedging face which is fixed with respect to the housing which is in contact with the periphery of the battery in the mounted position so as to immobilize the battery horizontally in all directions.

15. The arrangement as claimed in claim 14, wherein the wedging face is formed by an annular interior face forming a rigid surround that horizontally surrounds the battery and that is in contact along its entire length with the periphery of the battery in the mounted position so as to block horizontal movements of the battery in all directions.

16. The arrangement as claimed in claim 15, wherein at least one pad of elastically deformable material is interposed horizontally with preload between the annular interior face and the battery in the mounted position so as to absorb any mounting clearances there are between the battery and the annular interior face so as to ensure that the battery is immobilized relative to a chassis of the vehicle horizontally in all directions.

17. The arrangement as claimed in claim 14, wherein the wedging face is formed of an interior face of a rigid frame which is fixed to the chassis of the motor vehicle.

18. The arrangement as claimed in claim 14, further comprising vertical buffer means against which the battery abuts in its mounted position.

19. The arrangement as claimed in claim 18, wherein the annular wedging face has a frustoconical shape which collaborates with a counterpart that surrounds the battery horizontally so as to block vertical movement of the battery in the direction of mounting when it is in the mounted position.

20. The arrangement as claimed in claim 19, wherein the counterpart is produced as an integral part of the battery.

21. The arrangement as claimed in claim 19, wherein the counterpart is formed of the frustoconical exterior face of a rim which projects horizontally outward from the vertical faces of the battery.

22. The arrangement as claimed in claim 14, further comprising locking means for locking the battery in the mounted position and which block vertical movement of the battery in the opposite direction to the direction of mounting.

23. The arrangement as claimed in claim 22, wherein the locking means comprises at least one hook-shaped catch that is mounted to pivot between a released position in which the battery is free to slide vertically and a locked position in which the battery is trapped in the housing in the mounted position.

24. The arrangement as claimed in claim 23, wherein, in its locked position, the hook-shaped catch is configured to catch under a free lip of the rim.

25. The arrangement as claimed in claim 23, wherein, in its locked position, the hook-shaped catch is configured to catch on a ring borne by the battery.

26. The arrangement as claimed in claim 23, wherein an axis of pivoting of the hook-shaped catch is arranged, in a direction of gravity, in line with a point of contact between the battery and the hook-shaped catch in the locked position.
